(19) United States
(12) Patent Application Publication
(10) Pub. No.: US 2011/0032433 A1
(43) Pub. Date: Feb. 10, 2011

(54) CONNECTION STATE DISPLAY CONTROLLER, CONTENT PROCESSOR, CONTENT PROCESSING SYSTEM, CONNECTION STATE DISPLAY CONTROL METHOD, ITS PROGRAM AND RECORDING MEDIUM RECORDING THE PROGRAM

(75) Inventor: Yoshifumi Sato, Machida (JP)

Correspondence Address: KRATZ, QUINTOS & HANSON, LLP, 1420 K Street, N.W., 4th Floor, WASHINGTON, DC, 20005, US

(73) Assignee: PIONEER CORPORATION, Kawasaki-shi (JP)

(21) Appl. No.: 12/921,629

(22) PCT Filed: Mar. 13, 2008
(86) PCT No.: PCT/JP2008/054629

§ 371 Date: Oct. 22, 2010

(51) Int. Cl. H04N 5/268

(52) U.S. Cl. 348/705; 348/E05.057

(57) ABSTRACT

In a display device of an AV system, when first to seventh video sound output devices are connected to first to fourth input terminals via the AV receiver and an HDDVD recorder, the display device instructs a display section to display connection information including to-be-displayed device information for the first to seventh video sound output devices including a stored content transmitting function and the HDDVD recorder and not including to-be-displayed device information for the AV receiver having no stored content transmitting function. Accordingly, even when a number of devices only having a repeater function are connected between the display device and a device having a stored content transmitting function, to-be-displayed device information only for a device having a stored content transmitting function can be displayed and a user can easily specify the device having the stored content transmitting function.

### TECHNICAL FIELD

The present invention relates to a connection state display controller that instructs a display section to display a connection state when a transmitter is connected to an input terminal of a content processor via a transfer unit, the content processor, a content processing system, a connection state display control method, a program thereof and a recording medium that records the program.

### BACKGROUND ART

There has been traditionally known an arrangement in which a plurality of devices are connected to each other in a hierarchical tree having a plurality of levels where a processing content of a device at the lowest level is output from a device at the highest level (see, for instance, Patent Literatures 1 and 2). Moreover, there has been known an arrangement in which imaginary folders where images are classified are displayed in a hierarchical tree having a plurality of levels (see, for instance, Patent Literature 3).

Patent Literature 1 discloses an arrangement including components 1 to 4. To an input terminal of the component 4, output terminals of the components 1 and 2 are connected. To an input terminal of the component 1, an output terminal of the component 3 is connected. The components 1 to 4 are connected to a control bus.

An output signal output from the component 3 is transmitted to the component 4 via the component 1 and is processed at the component 4 as needed.

Patent Literature 2 discloses an arrangement including a display, an AV (Audio Visual) switch connected to the display by HDMI (High-Definition Multimedia Interface), and three STBs (Set Top Box) respectively connected to three receiving interfaces of the AV switch by HDMI.

The display transfers a remote control code sent from a remote controller to the AV switch. The AV switch transfers AV data from an STB corresponding to the remote control code to the display. The transferred AV data are displayed and reproduced on the display.

Patent Literature 3 discloses an arrangement in which images in a selection folder are classified into different categories at a predetermined time interval and having a hierarchical structure, and icons of the categories in which the images are classified are displayed in a tree structure.

Patent Literature 1 JP-T-2007-524285

Patent Literature 2 JP-A-2004-208290

Patent Literature 3 JP-A-2007-58792

### DISCLOSURE OF THE INVENTION

### Problems to be Solved by the Invention

For displaying connection states of the devices in the arrangements disclosed in Patents Literatures 1 and 2, it is considered to display the connection states in a tree structure by using the arrangement of Patent Literature 3. However, in such an arrangement for displaying in a tree structure, not only information to represent a device for transmitting an image signal to be displayed on a display device (hereinafter, referred to as a transmitter) but also information to represent a device that has only a content transfer function of an image signal and is interposed between the transmitter and the display device (hereinafter, referred to as a transfer device) are displayed.

Accordingly, when levels of the tree-structure are increased in accordance with increase in the number of the transfer device, a lot of information indicating the transfer devices are displayed. Consequently, it may become difficult to specify a transmitter for transmitting an image signal to be actually displayed on the display device.

Further, while an HDDVD (High Definition DVD) recorder records a content signal output from other video sound output devices, even if the HDDVD recorder also functions as a tuner, the HDDVD cannot transmit a content signal from the tuner outward but may only transfer a content signal input to the HDDVD outward. Also a tuner to which no antenna is connected and a DVD player in which no DVD disc is inserted cannot output a content signal outward. In such a case, on specifying the transmitter that transmits the image signal to be actually displayed, it is more understandable to a user to specify a transmitter capable of actually transmitting a content signal.

An object of the invention is to provide a connection state display controller capable of easily specifying a transmitter transmitting a content signal, content processor, content processing system, connection state display control method, a program thereof and a recording medium recording the program.

Another object of the invention is to provide a connection state display controller capable of easily specifying a transmitter whose function to transmit a content signal is actually executable, content processor, content processing system, connection state display control method, a program thereof and a recording medium recording the program.

### Means for Solving the Problems

A connection state display controller according to an aspect of the invention is provided in a content processor including a display section capable of displaying various information, an input terminal capable of inputting a content signal having at least one of a sound signal and an image signal and a content processing section that processes the content signal to be input via the input terminal, in which, when a signal processor having a content generating function for generating the content signal is provided as a transmitter, and a signal processor not having the content generating function but having a content transfer function for transferring the content signal is provided as a transfer device, the transmitter for transmitting the content signal is connected to the input terminal via the transfer device, the connection state display controller instructs the display section to display a connection state between the transmitter and the transfer device, the connection state display controller comprising: a connection information generating unit that recognizes the connection state to generate connection information including to-be-displayed device information for specifying the transmitter and the transfer device respectively; and a connection information display controlling unit that instructs the display section to display only the to-be-displayed device information for the transmitter, or instructs the display section to display the to-be-displayed device information for the transmitter and the to-be-displayed device information for the transfer device in different display forms.

The content processor according to another aspect of the invention includes a display section capable of displaying various information, an input terminal capable of inputting a content signal having at least one of a sound signal and an image signal, a content processing section that processes the content signal to be input via the input terminal, and the above-described connection state display controller.

A content processing system according to still another aspect of the invention includes the above-described content processor, the transmitter and the transfer device.

A connection state display control method according to further aspect of the invention serves as a computer provided in a content processor including a display section capable of displaying various information, an input terminal capable of inputting a content signal having at least one of a sound signal and an image signal and a content processing section that processes the content signal to be input via the input terminal, in which, when a signal processor having a content generating function for generating the content signal is provided as a transmitter, and a signal processor not having the content generating function but having a content transfer function for transferring the content signal is provided as a transfer device, the transmitter for transmitting the content signal is connected to the input terminal via the transfer device, the connection state display controller instructs the display section to display a connection state between the transmitter and the transfer device, the computer recognizing the connection state to generate connection information including to-be-displayed device information for specifying the transmitter and the transfer device respectively; and instructing the display section to display only the to-be-displayed device information for the transmitter, or instructing the display section to display the to-be-displayed device information for the transmitter and the to-be-displayed device information for the transfer device in different display forms.

A connection state display controlling program according to still further aspect of the invention instructs a computer to execute the above-described connection state display control method.

A connection state display controlling program according to the still further aspect of the invention instructs a computer to serve as the above-described connection state controller.

A recording medium according to still further aspect of the invention records the above-described connection state display controlling program in a manner readable by a computer.

### BRIEF DESCRIPTION OF DRAWINGS

FIG. 1 is a block diagram showing a schematic arrangement of an AV system according to an exemplary embodiment of the invention.

FIG. 2 is a block diagram showing a schematic arrangement of an HDDVD recorder and a video sound output device according to the exemplary embodiment.

FIG. 3 is a schematic diagram showing a recorder input terminal list according to the exemplary embodiment.

FIG. 4 is a block diagram showing a schematic arrangement of an AV receiver according to the exemplary embodiment.

FIG. 5 is a schematic diagram showing a receiver input terminal list according to the exemplary embodiment.

FIG. 6 is a block diagram showing a schematic arrangement of a display device according to the exemplary embodiment.

FIG. 7 is a schematic diagram showing a display input terminal list according to the exemplary embodiment.

FIG. 8 is a schematic diagram showing an optimized connection configuration list according to the exemplary embodiment.

FIG. 9 is a flow chart showing a creation of the optimized connection configuration list according to the exemplary embodiment.

FIG. 10 is a flow chart showing a judgment processing of an input terminal according to the exemplary embodiment.

FIG. 11 is a flow chart showing a repeater input terminal judgment processing according to the exemplary embodiment.

FIG. 12 is a schematic diagram showing a display state of connection information when a screen display name is not changed according to the exemplary embodiment.

FIG. 13 is a schematic diagram showing a display state of connection information when a screen display name is changed according to the exemplary embodiment.

FIG. 14 is a schematic diagram showing a recorder input terminal list according to a modification of the invention.

FIG. 15 is a schematic diagram showing a receiver input terminal list according to the modification.

FIG. 16 is a schematic diagram showing a display input terminal list according to the modification.

FIG. 17 is a schematic diagram showing an optimized connection configuration list according to the modification.

FIG. 18 is a schematic diagram showing a display state of connection information when a screen display name is not changed according to the modification.

FIG. 19 is a schematic diagram showing a display state of connection information according to another modification of the invention.

FIG. 20 is a schematic diagram showing a display state of connection information according to still another modification of the invention.

FIG. 21 is a schematic diagram showing a display state of connection information according to further modification of the invention.

### EXPLANATION OF CODES

1 AV system serving as content processing system

100 display device serving as content processor

101 to 104 first to fourth input terminals

111 display section

112 display input extension configuration memory serving as input terminal processing information storage

113 connection state display controller serving as computer

113A on-screen processor serving as connection information display controlling unit

113B display input extension processing controller serving as connection information generating unit and determination-signal transmitter

114 video switch processor serving as content processing section

160 optimized connection configuration list serving as input terminal processing information

163 optimized input terminal information serving as input terminal information

166 image-quality adjustment setting information serving as processing type information

170, 500 connection information

171, 501 to-be-displayed device information

200 AV receiver serving as transfer device

300 HDDVD recorder serving as first transmitter

305 storage

306A transmitted content transfer section

306B stored content transmission section

401 to 406 first to sixth video sound output devices serving as third transmitter

407 seventh video sound output device serving as second transmitter

214, 309, 407E power supply controlling unit

215, 310, 407F notifier

### BEST MODE FOR CARRYING OUT THE INVENTION

Exemplary embodiment(s) of the invention will be described below with reference to the attached drawings.

An exemplary embodiment will be exemplified by an AV system serving as a content processing system, in which a plurality of devices are connected to a display device serving as a content processing device in a hierarchical tree having a plurality of level via an HDMI cable according to the HDMI standard. The HDMI cable includes a data line and a control line.

Herein, for instance, a content signal to be processed in the AV system includes a video signal as an image signal and a sound signal. However, the content signal to be processed may only include either a video signal or a sound signal. An usable transmission method of signals is not limited to one according to the HDMI standard, but may include video sound transmission method with use of an MPEG compressed data according to IEEE (The Institute of Electrical and Electronics Engineers) 1394 standard, a component video transmission method of Y (brightness signal)/Pb (blue color-difference signal)/Pr (red color-difference signal) with use of D-video terminal (also referred to as D terminal), an optical digital sound transmission method with use of a digital audio format according to IEC (International Electrotechnical Commission) 60958 standard and IEC 61937 standard, and the like.

Hereinafter, a repeater function (content transfer function) means a function that a device is capable of transferring a video signal, sound signal and control signal. A video signal, sound signal and control signal which are input to a device having such a repeater function are transmitted from an output terminal of the device. A stored content transmitting function serving as a content generating function means a function to read out a content signal stored in a storage of the device and output the content signal. The repeater function and the storage content transmission function will be sometimes collectively referred to as a repeater content transmission function for an explanation sake.

### Arrangement of AV System

Firstly, an arrangement of the AV system will be described.

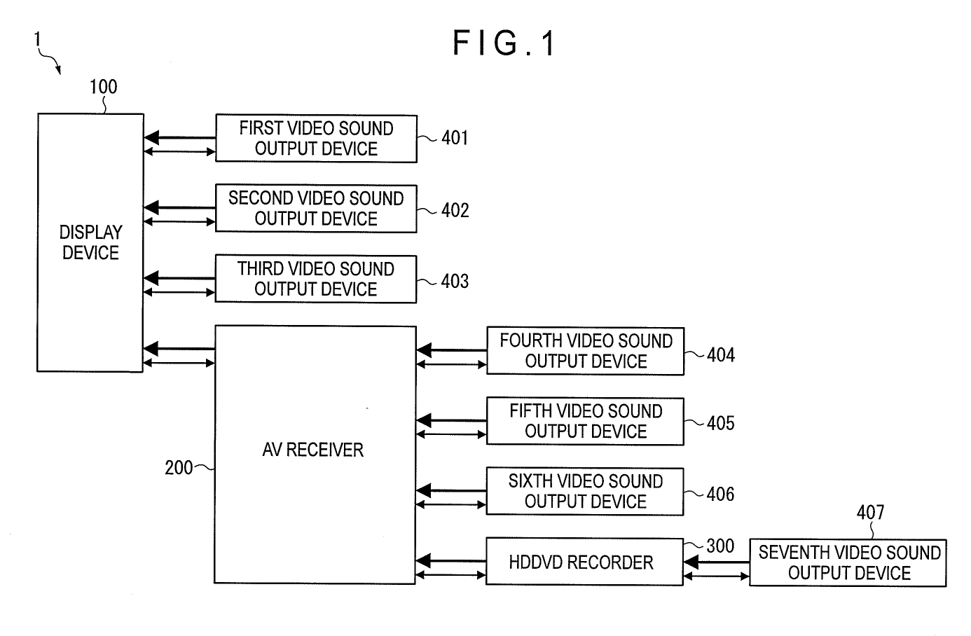

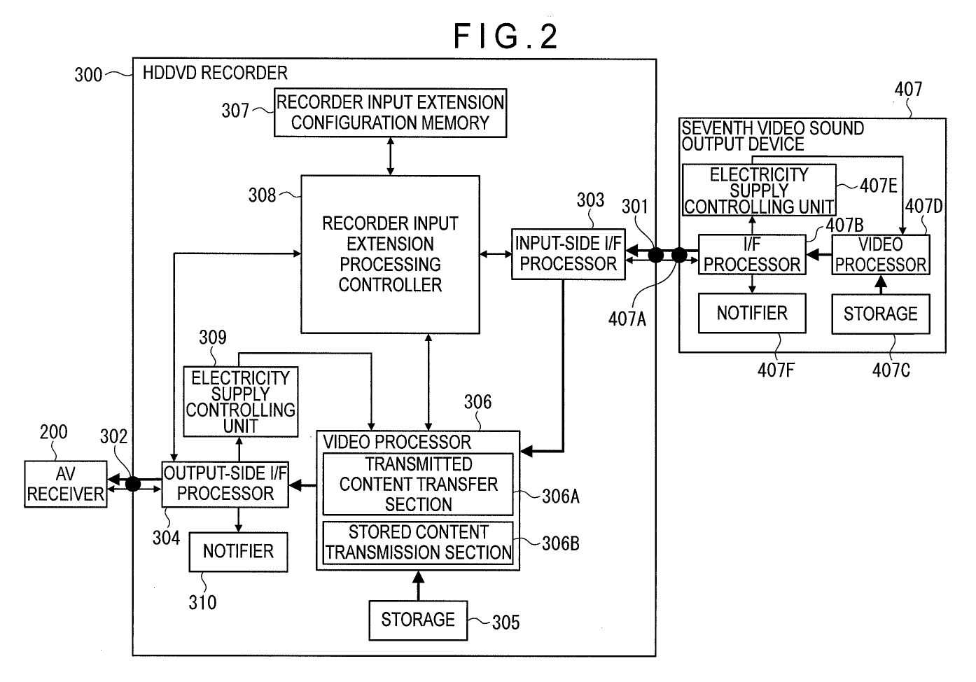

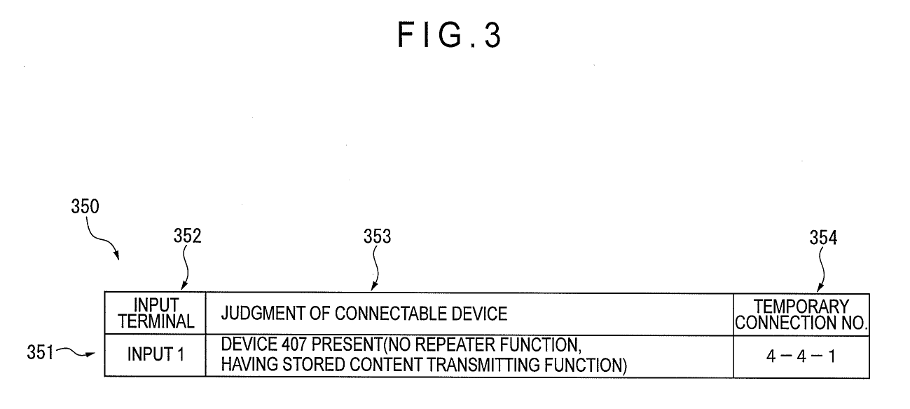

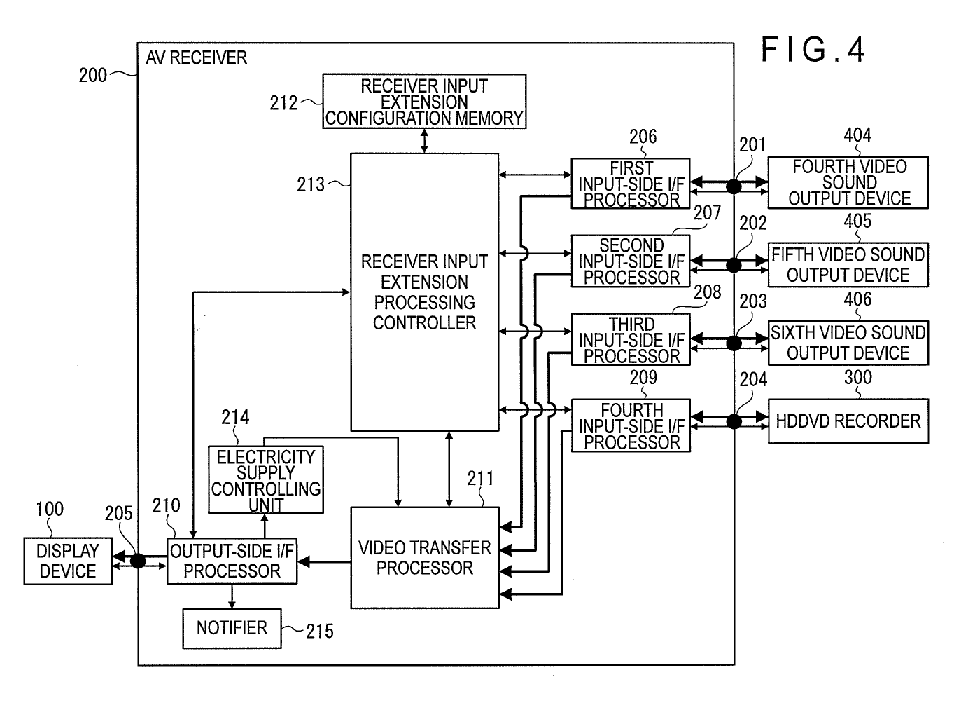

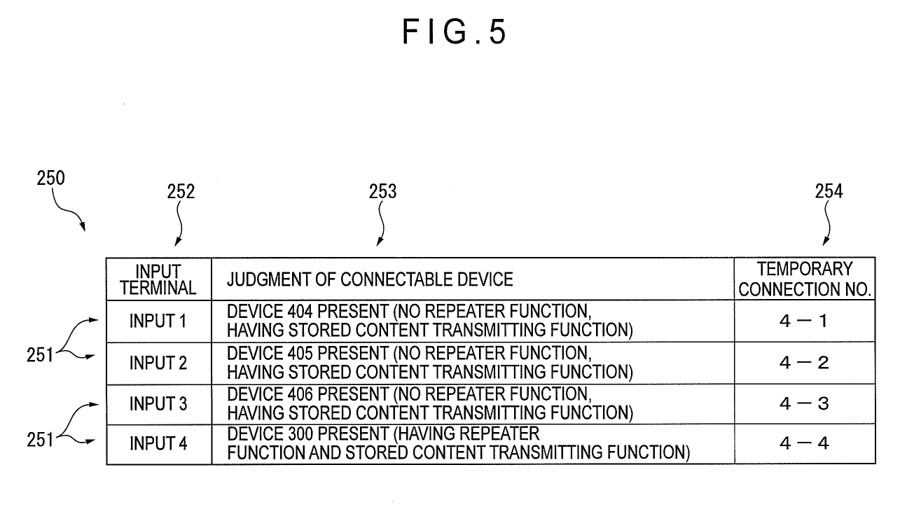

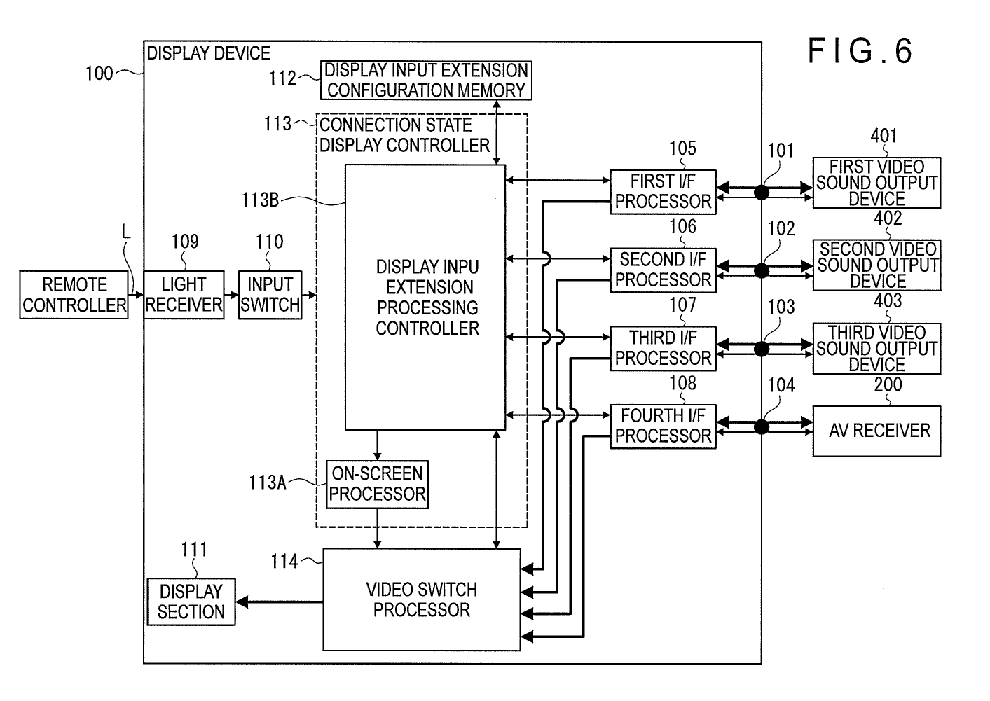

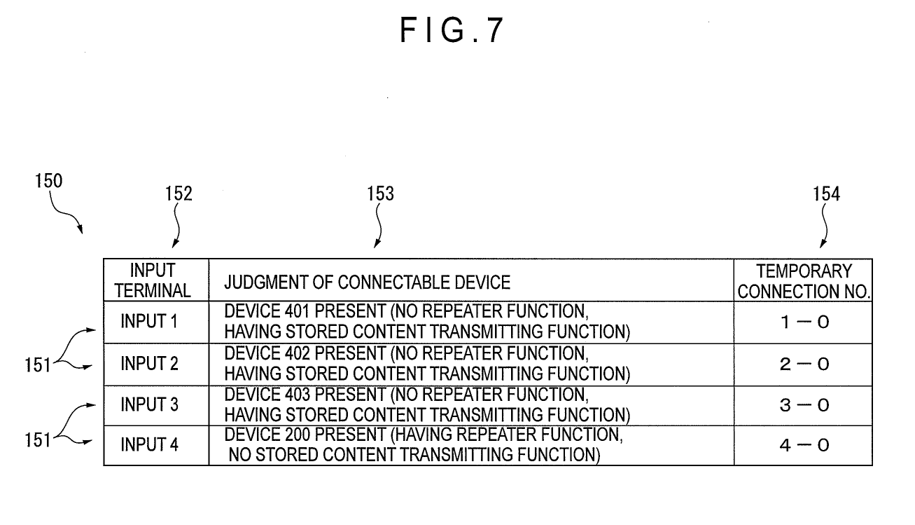

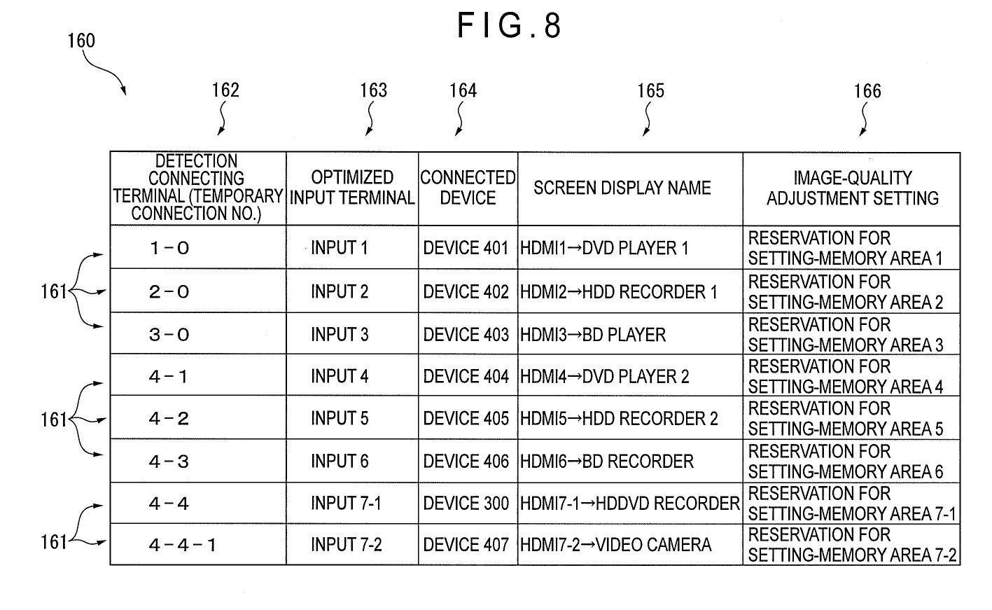

FIG. 1 is a block diagram showing a schematic arrangement of the AV system. FIG. 2 is a block diagram showing a schematic arrangement of an HDDVD recorder and a video sound output device. FIG. 3 is a schematic diagram showing a recorder input terminal list. FIG. 4 is a block diagram showing a schematic arrangement of an AV receiver. FIG. 5 is a schematic diagram showing a recorder input terminal list. FIG. 6 is a block diagram showing a schematic arrangement of a display device. FIG. 7 is a schematic diagram showing a display input terminal list. FIG. 8 is a schematic diagram showing an optimized connection configuration list.

As shown in FIG. 1, an AV system 1 serving as a content processing system includes: a display device 100 serving as a content processor; an AV receiver 200 serving as a transfer device; an HDDVD recorder 300 serving as a first transmitter; first to sixth video sound output devices 401 to 406 serving as a third transmitter; and a seventh video sound output device 407 serving as a second transmitter. Herein, the first to seventh video sound output devices 401 to 407 are, for instance, a first DVD player (DVD player 1), a first HDD recorder (HDD recorder 1), BD (Blue-ray Disc) player, a second DVD player (DVD player 2), a second HDD recorder (HDD recorder 2), BD recorder and a video camera.

The display device 100 is connected to the AV receiver 200 and the first to third video sound output devices 401 to 403. The display device 100 is also connected to the HDDVD recorder 300 and the fourth to sixth video sound output devices 404 to 406 via the AV receiver 200. The display device 100 is further connected to the seventh video sound output device 407 via the HDDVD recorder 300. In other words, the AV receiver 200, the HDDVD recorder 300 and the first to seventh video sound output devices 401 to 407 are connected to the display device 100 in a tree structure having three levels.

To the display device 100, content signals are respectively input from the first to seventh video sound output devices 401 to 407 that are connected to an end of the tree structure and from the HDDVD recorder 300 having the repeater content transmission function. Thus, the display device 100 can display the content signals. An arrangement of the display device 100 will be specifically described below.

In FIGS. 1, 2, 4 and 6, two kinds of lines are used for drawing a connecting line of components: a bold line represents a data line for transmitting and receiving data such as a video signal and a sound signal; and a fine line represents a control line for transmitting and receiving a signal such as a control signal for displaying an image and outputting a sound. A component for processing the sound signal is not shown. An interface processor is referred to as an I/F processor.

As shown in FIG. 2, the seventh video sound output device 7 includes an output terminal 407A, an I/F processor 407B, a storage 407C, a video processor 407D, an power supply controlling unit 407E, and a notifier 407F. The seventh video sound output device 407 has a stored content transmitting function, but does not have a repeater function. A signal to the effect is sent to the HDDVD recorder 300 at an authentication processing described below.

The HDMI cable is attachable and detachable to the output terminal 407A. The storage 407C suitably readably stores a content signal. The storage 407C is exemplified by a drive and a driver that readably store data in a recording medium such as an HD, DVD, optical disc and a memory card.

The video processor 407D is actuated by power supplied from the power supply controlling unit 407E, reads out the content signal in the storage 407C and transmits the content signal to the HDDVD recorder 300 via the I/F processor 407B.

On receiving a determination signal indicating that the seventh video sound output device 407 is determined as a device for outputting the content signal, the power supply controlling unit 407E supplies power to the video processor 407D and actuates the video processor 407D.

On receiving the determination signal via the I/F processor 407B, the notifier 407F notifies the reception. Examples of the notifier 407F are an emitting device such as an LED that notifies a variety of information by light, and a sound output device such as a speaker that notifies those by sound.

A storage 305, power supply controlling units 309 and 214 and notifiers 310 and 215 (described below) of the HDDVD recorder 300 and the AV receiver 200 are arranged in the same manner as the storage 407C, the power supply controlling unit 407E and the notifier 407F. Accordingly, the arrangements thereof will be not described below.

The HDDVD recorder 300 includes an input terminal 301, an output terminal 302, an input-side I/F processor 303, an output-side I/F processor 304, a storage 305, a video processor 306, a recorder input extension configuration memory 307, a recorder input extension processing controller 308, an power supply controlling unit 309, and a notifier 310. The HDDVD recorder 300 has a repeater function and a stored content transmitting function. A signal to the effect is transmitted to the AV receiver 200 at an authentication processing.

The HDMI cable is attachable and detachable to the input terminal 301 and the output terminal 302.

The video processor 306 includes a transmitted content transfer section 306A and a stored content transmission section 306B.

The transmitted content transfer section 306A receives a content signal transmitted from the seventh video sound output device 407 via the input-side I/F processor 303. The transmitted content transfer section 306A processes the content signal as needed and transfers the processed content signal to the AV receiver 200 via the output-side I/F processor 304.

When the stored content transmission section 306B recognizes a command to transmit a content signal of the storage 305, the stored content transmission section 306B reads out the content signal from the storage 305, processes the content signal as needed and transmits the processed content signal to the AV receiver 200.

The recorder input extension configuration memory 307 stores a recorder input terminal list 350 as shown in FIG. 3 in a manner to be capable of reading out as needed.

The recorder input terminal list 350 includes input terminal connection configuration information 351 about a device connected to the input terminal 301. The input terminal connection configuration information 351 includes terminal name information 352, connected device judgment information 353 and temporary connection number information 354.

The terminal name information 352 shows, for instance, a name of the input terminal 301 set in advance. The connected device judgment information 353 shows whether a device is connected to the input terminal 301 and whether the connected device has a repeater function and a stored content transmitting function. The temporary connection number information 354 shows a temporary connection number set in advance in an entirety of the AV system 1.

The recorder input extension processing controller 308 updates the recorder input terminal list 350 as needed based on an authentication result against the device connected to the input terminal 301. The recorder input extension processing controller 308 transmits the updated recorder input terminal list 350 to the AV receiver 200. An operation of the recorder input extension processing controller 308 will be specifically described below.

The AV receiver 200 includes first to fourth input terminals 201 to 204, an output terminal 205, first to fourth input-side I/F processors 206 to 209, an output-side I/F processor 210, a video transfer processor 211, a receiver input extension configuration memory 212, a receiver input extension processing controller 213, an power supply controlling unit 214, and a notifier 215. The AV recorder 200 has a repeater function, but does not have a stored content transmitting function. The AV receiver 200 transmits a signal to the effect to the display device 100 at an authentication processing.

The HDMI cable is attachable and detachable to the first to fourth input terminals 201 to 204 and the output terminal 205.

The video transfer processor 211 receives content signals transmitted from the fourth to sixth video sound output devices 404 to 406 and the HDDVD recorder 300 via the first to fourth input-side I/F processors 206 to 209. The video transfer processor 211 processes any one of the content signals as needed and transfers the processed content signal to the display device 100 via the output-side I/F processor 210.

The receiver input extension configuration memory 212 stores a recorder input terminal list 250 as shown in FIG. 5 in a manner to be capable of reading out as needed.

The receiver input terminal list 250 includes four pieces of input terminal connection configuration information 251 about devices respectively connected to the first to fourth input terminals 201 to 204. The input terminal connection configuration information 251 includes terminal name information 252, connected device judgment information 253 and temporary connection number information 254, which include the same contents as those of the terminal name information 352, connected device judgment information 353 and temporary connection number information 354 of the recorder input terminal list 350.

The receiver input extension processing controller 213 updates the receiver input terminal list 250 as needed based on an authentication result against the devices connected to the first to fourth input terminals 201 to 204, and transmits the updated receiver input terminal list 250 to the display device 100. The receiver input extension processing controller 213 transfers the recorder input terminal list 350 transmitted from the HDDVD recorder 300 to the display device 100. An operation of the receiver input extension processing controller 213 will be specifically described below.

As shown in FIG. 6, the display device 100 includes first to fourth input terminals 101 to 104, first to fourth I/F processors 105 to 108, a light receiver 109, an input switch 110, display section 111, a display input extension configuration memory 112 serving as an input terminal processing information storage, a connection state display controller 113 serving as a computer, and a video switch processor 114 serving as a content processing section.

The HDMI cable is attachable and detachable to the first to fourth input terminals 101 to 104.

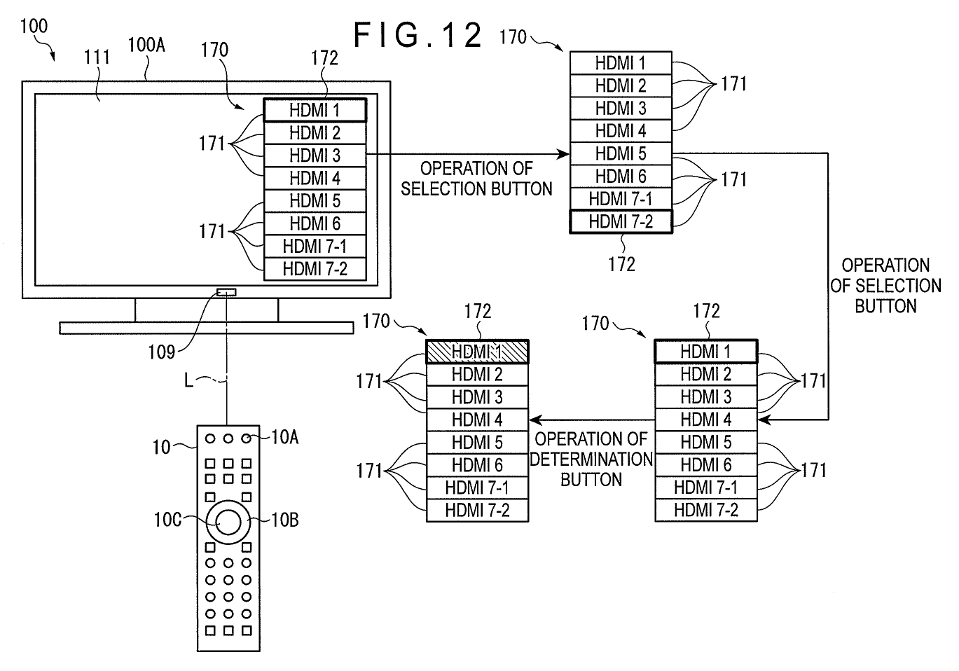

A part of the light receiver 109 is exposed out of a case 100A (see FIG. 12) of the display device 100. The light receiver 109 receives infrared light L from a remote controller 10 and transmits an operation signal transmitted by using the infrared light L to the input switch 110.

The input switch 100 outputs a processing signal on selection of the first to seventh video sound output devices 401 to 407 that transmit a content to be watched or listened by a user and the HDDVD recorder 300 to the connection state display controller 113.

The display section 111 displays video and the like based on a video signal output from the video switch processor 114. The display section 111 is exemplified by a liquid crystal panel, an organic EL (Electro Luminescence) panel, PDP (Plasma Display Panel), CRT (Cathode-Ray Tube), FED (Field Emission Display), and an electrophoretic display panel.

The display input extension configuration memory 112 stores a display input terminal list 150 as shown in FIG. 7 and an optimized connection configuration list 160 as an input terminal processing information as shown in FIG. 8 in a manner to be capable of reading out as needed.

The display input terminal list 150 includes four pieces of input terminal connection configuration information 151 on devices connected to the first to fourth input terminals 101 to 104. Specifically, the input terminal connection configuration information 151 includes terminal name information 152, connected device judgment information 153 and temporary connection number information 154, which include the same contents as those of the terminal name information 252, connected device judgment information 253 and temporary connection number information 254 of the receiver input terminal list 250.

The optimized connection configuration list 160 is created based on the display input terminal list 150, receiver input terminal list 250 and recorder input terminal list 350. The optimized connection configuration list 160 is optimized connection configuration information 161 only on a device at least having a stored content transmitting function among the devices connected to the display device 100. The optimized connection configuration information 161 includes detection connection terminal information 162, optimized input terminal information 163 as input terminal information, connected device information 164, screen display name information 165 and image-quality adjustment setting information 166 as processing type information.

The detection connection terminal information 162 shows the same content as those of the temporary connection number information 154, 254 and 354.

The optimized input terminal information 163 represents an optimized terminal name of the display device 100 supposed to have all the terminals represented by temporary connection numbers according to the detection connection terminal information 162.

The connected device information 164 represents a name, model and the like of the devices shown by the connected device judgment information 353,253,153.

The screen display name information 165 represents a display name of a terminal displayed on the display section 111 as to-be-displayed device information 171 described below. The screen display name information 165 records a display name set in advance or a display name changed by a user. Herein, “HDMI1→DVD player 1” represents that a display name of “HDMI1” set in advance is changed to a display name of “DVD player 1.”

The image-quality adjustment setting information 166 represents a memory area in which information for image adjustment is stored. Herein, “RESERVATION FOR SETTING-MEMORY AREA 1” means to display a content based on a content signal from a device connected to an “INPUT 1” terminal on the display section 111 under adjustment conditions of an image-quality and a screen size of the setting-memory area 1 (not shown) of the display input extension configuration memory 112.

The connection state display controller 113, which is composed of various programs, includes an on-screen processor 113A serving as a connection information display controlling unit and a display input extension processing controller 113B serving as a connection information generator and a determination-signal transmitter.

The on-screen processor 113A receives the optimized connection configuration list 160 from the display the input extension processing controller 113B based on a user's operation of the remote controller 10 and displays connection information 170 (see FIG. 12) having the same number of pieces of the to-be-displayed device information 171 as that of the optimized connection configuration information 161 on the display section 111.

The to-be-displayed device information 171 is information for specifying the first to seventh video sound output devices 401 to 407 and the HDDVD recorder 300. In other words, the connection information 170 includes the information for specifying the first to seventh video sound output devices 401 to 407 and the HDDVD recorder 300 which have the stored content transmitting function, but does not include information for specifying the AV receiver 200 which has no stored content transmitting function.

Other processing on the connection information 170 of the on-screen processor 113A will be described below.

The display input extension processing controller 113B creates the input terminal connection configuration information 150 and the optimized connection configuration list 160. The display input extension processing controller 113B also changes the contents of the screen display name information 165 and the image-quality adjustment setting information 166. A creation of the display input terminal list 150 and the optimized connection configuration list 160 will be described below.

On receiving a signal input from the input switch 110 to display a content of a content signal from a predetermined device, the display input extension processing controller 113B controls the video switch processor 114 to display the content on the display section 111. The display input extension processing controller 113B also transmits a determination signal to the predetermined device and a device interposed between the predetermined device and the display device 100 to instruct those devices to notify that the content is displayed.

The video switch processor 114 instructs the display section 111 to display a content of the image-quality and the screen size based on the image-quality adjustment setting information 166 according to the content signal of the devices connected to the first to fourth input terminals 101 to 104 by the control of the display input extension processing controller 113B.

### Operation of AV System

Next, an operation of the AV system 1 will be described.

### Creation of Optimized Connection List

Firstly, as an operation of the AV system 1, a creation of the optimized connection configuration list 160 will be described below.

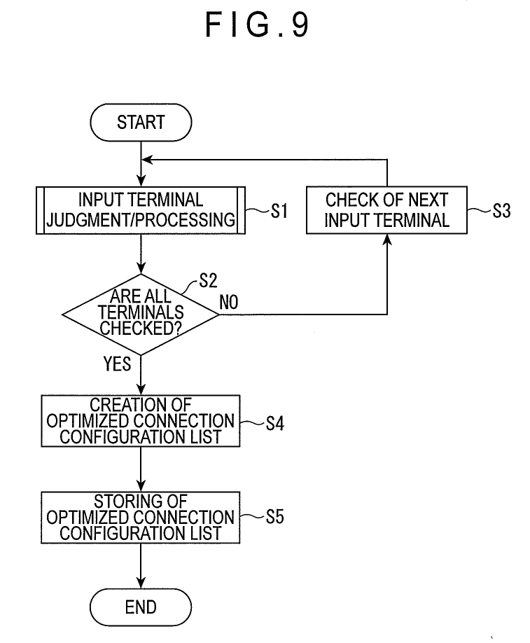

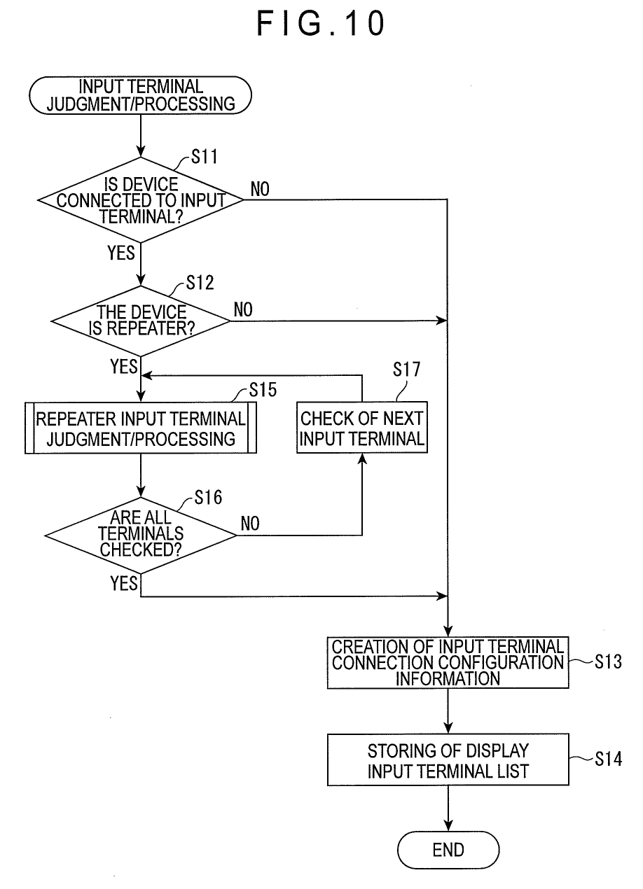

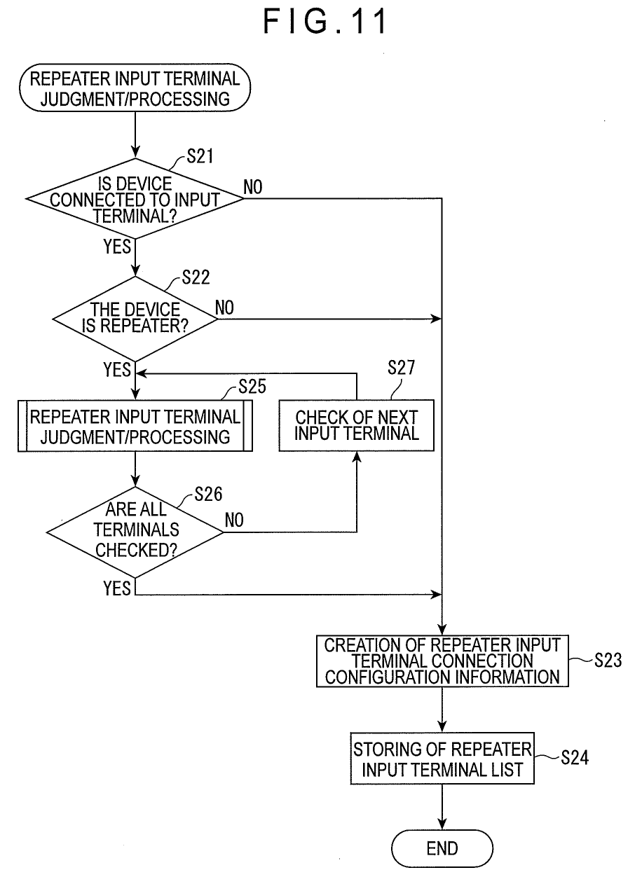

FIG. 9 is a flow chart showing a creation of the optimized connection configuration list. FIG. 10 is a flow chart showing an input terminal judgment processing. FIG. 11 is a flow chart showing a repeater input terminal judgment processing.

After respective devices are connected to each other as shown in FIG. 1, the display device 100 of the AV system 1 is firstly actuated, in conjunction with which the respective devices are operated. The display device 100, AV receiver 200 and HDDVD recorder 300 detect devices connected thereto and create the optimized connection configuration list 160.

Specifically, as shown in FIG. 9, the display device 100 performs the input terminal judgment processing that creates the display input terminal list 150 based on connection states of the first to fourth input terminals 101 to 104 at the display input extension processing controller 113B of the connection state display controller 113 (Step S1).

Subsequently, the display input extension processing controller 113B judges whether or not the connection states of all the input terminals are checked (Step S2). In Step S2, on judging that all the input terminals have not been checked, the display input extension processing controller 113B checks an input terminal whose connection state should be checked next (Step S3), and completes the processing of Step 51. On the other hand, on judging that the connection states of all the input terminal have been checked and the display input terminal list 150 is created in Step S2, the display input extension processing controller 113B performs an optimization processing of all the input terminals according to respective input terminal connection configurations and creates the optimized connection configuration list 160 (Step S4).

Specifically, the display input extension processing controller 113B recognizes a device having a stored content transmitting function based on the display input terminal list 150, the receiver input terminal list 250 created by the AV receiver 200, and the recorder input terminal list 350 created by the HDDVD recorder 300.

For instance, when the recorder input terminal list 300 as shown in FIG. 3 is created, the display input extension processing controller 113B recognizes the seventh video sound output device 407 as a device having a stored content transmitting function. When the receiver input terminal list 250 as shown in FIG. 5 is created, the display input extension processing controller 113B recognizes the fourth to sixth video sound output devices 404 to 406 and the HDDVD recorder 300 as a device having a stored content transmitting function. When the display input terminal list 150 as shown in FIG. 7 is created, the display input extension processing controller 113B recognizes the first to third video sound output devices 401 to 403 as a device having a stored content transmitting function and the AV receiver 200 as a device having no stored content transmitting function.

The display input extension processing controller 113B creates the optimized connection configuration information 161 about respective device having the stored content transmitting function and lists the optimized connection configuration information 161 to create the optimized connection configuration list 160.

Subsequently, the display input extension processing controller 113B stores the created optimized connection configuration list 160 in the display input extension configuration memory 112 (Step S5).

On creation of the optimized connection configuration information 161, the display input extension processing controller 113B creates characters representing “HDMIP-Q (in which P and Q are natural numbers) as screen display name information 165 of a device having a repeater content transmission function. The display input extension processing controller 113B also creates characters “HDMIP-Q (in which P and Q are natural numbers) as screen display name information 165 of a device only having a stored content transmitting function, the device being connected to the display device 100 via a device having a repeater content transmission function. The display input extension processing controller 113B also creates characters “HDMIL (in which L is natural numbers) as screen display name information 165 of a device connected to the display device 100 via a device only having a repeater function, or a device directly connected to the display device 100.

For instance, as shown in FIG. 8, the display input extension processing controller 113B creates characters “HDMI1 (to 6)” as screen display name information 165 of the first to third video sound output devices 401 to 403 directly connected to the display device 100 and the fourth to sixth video sound output devices 404 to 406 connected via the AV receiver 200 only having a repeater function. The display input extension processing controller 113B also creates characters “HDMI7-1 (2) as screen display name information 165 of the HDDVD recorder 300 having a repeater content transmission function and the seventh video sound output device 407 connected via the HDDVD recorder 300.

On the other hand, at the input terminal judgment processing in Step 51, the display input extension processing controller 113B performs a recognition processing via respective I/F processors 105 to 108 as shown in FIG. 10, thereby judging whether a device connected to each of the input terminals 101 to 104 is present (Step S11). In Step S11, on judging that a device is connected, the display input extension processing controller 113B judges whether the connected device has a repeater function.

In Step S12, when the display input extension processing controller 113B judges that the first to third video sound output devices 401 to 403, which are connected to the first to third input terminals 101 to 103 whose connection states are to be checked, has no repeater function, or judges absence of a connected device in Step S11, the display input extension processing controller 113B creates the input terminal connection configuration information 151 about the input terminals (Step S13) and stores the input terminal connection configuration information 151 as the display input terminal list 150 (Step S14).

On the other hand, in Step S12, when the AV receiver 200, which is connected to the fourth input terminal 104 whose connection state is to be checked, has a repeater function, the display input extension processing controller 113B instructs the receiver input extension processing controller 213 of the AV receiver 200 to perform a repeater input terminal judgment processing for creating the receiver input terminal list 250 based on the connection states of the first to fourth input terminals 201 to 204 (Step S15).

Subsequently, the receiver input extension processing controller 213 judges whether the connection states of all the input terminals are checked (Step S16). On judging that all the input terminals have not been checked, the receiver input extension processing controller 213 checks another input terminal whose connection state is to be checked (Step S17) and performs Step S15 processing. On the other hand, on judging that the connection states of all the input terminal are checked and the receiver input terminal list 250 is created in Step S16, the display input extension processing controller 213 transmits a signal to the effect to the display input extension processing controller 113B. The display input extension processing controller 113B performs Step S13 processing and creates the input terminal connection configuration information 151 about the fourth input terminal 104.

On the other hand, in the repeater input terminal judgment processing in Step S15, the receiver input extension processing controller 213 performs a recognition processing via respective input-side I/F processors 206 to 209 as shown in FIG. 11, thereby judging whether a device is connected to each of the input terminals 101 to 104 (Step S21). In Step S21, on judging that a device is connected, the receiver input extension processing controller 213 judges whether the connected device has a repeater function (Step S22).

In Step S22, when the receiver input extension processing controller 213 judges that the first to third video sound output devices 404 to 406, which are connected to the first to third input terminals 201 to 203 whose connection states are to be checked, has no repeater function, or judges absence of a connection device in Step S21, the receiver input extension processing controller 213 creates the input terminal connection configuration information 251 about the input terminals (Step S23) and stores the input terminal connection configuration information 251 as display input terminal list 250 (Step S24).

On the other hand, in Step S22, when the HDDVD recorder 300, which is connected to the fourth input terminal 204 whose connection state is to be checked, has a repeater function, the receiver input extension processing controller 213 instructs the recorder input extension processing controller 308 of the HDDVD recorder 300 to perform a repeater input terminal judgment processing for creating the recorder input terminal list 350 based on the connection state of the input terminal 301 (Step S25).

Subsequently, the recorder input extension processing controller 308 judges whether the connection states of all the input terminals are checked (Step S26). On judging that check of all the input terminals is not finished, the recorder input extension processing controller 308 checks another input terminal whose connection state is to be checked (Step S27) and performs Step S25 processing. On the other hand, on judging that the connection states of all the input terminal are checked and the recorder input terminal list 350 is created in Step S26, the recorder input extension processing controller 308 transmits a signal to the effect to the receiver input extension processing controller 213. The receiver input extension processing controller 213 performs Step S23 processing and creates the input terminal connection configuration information 251 about the fourth input terminal 204.

During the repeater input terminal judgment processing by the recorder input extension processing controller 308 in Step S25, processings of Step 21 to Step 27 shown in FIG. 11 are performed. In Step S23, the receiver input extension processing controller 213 creates the input terminal connection configuration information 351 about the input terminal 301. In Step S24, the receiver input extension processing controller 213 stores the input terminal connection configuration information 351 as the recorder input terminal list 350.

### Display Processing of Connection Information

Next, a display processing of connection information 170 will be described as an operation of the AV system 1.

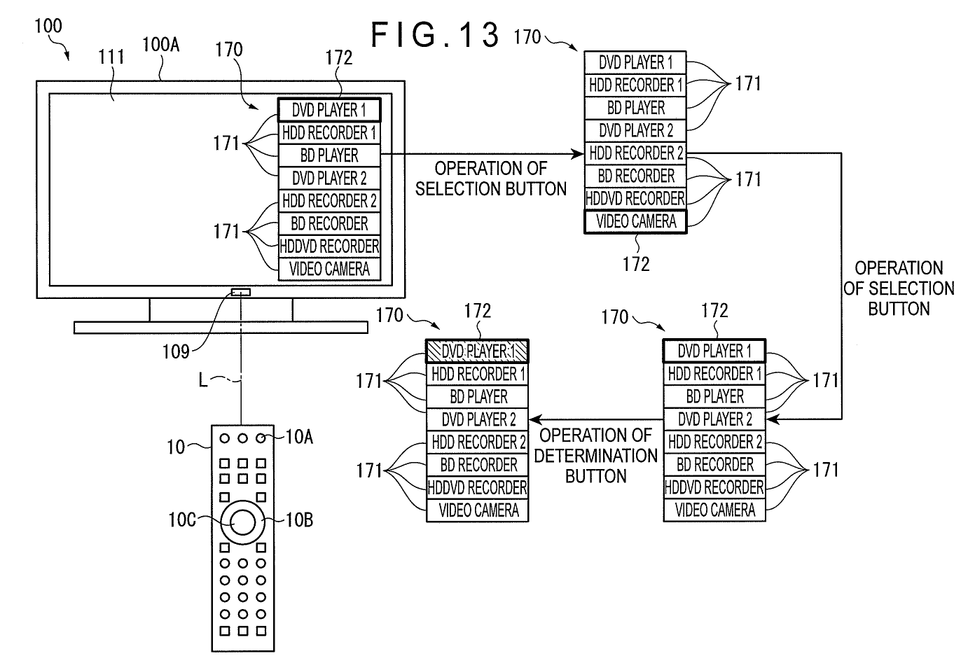

FIG. 12 is a schematic diagram showing a display state of connection information when a screen display name is not changed. FIG. 13 is a schematic diagram showing a display state of connection information when a screen display name is changed.

As shown in FIG. 12, when a user presses a selection button 10A of the remote controller 10 for selecting a predetermined input terminal, and the on-screen processor 113A of the display device 100 receives an operational signal to the effect from the input switch 110, the on-screen processor 113A receives the optimized connection configuration list 160 via the display input extension processing controller 113B. Based on the screen display name information 165 of the optimized connection configuration list 160, the on-screen processor 113A instructs the display section 111 to display the connection information 170 having eight pieces of to-be-displayed device information 171 which are the same number of pieces of the optimized connection configuration information 161. Moreover, the on-screen processor 113A displays a cursor 172 on a circumference of one piece of to-be-displayed device information 171.

Each time the selection button 10A or an arrow key 10B is pressed, the on-screen processor 113A moves the cursor 172 downward. When a determination button 10C of the remote controller 10 is pressed while the cursor 172 is positioned at a certain to-be-displayed device information 171, the on-screen processor 113A and the display input extension processing controller 113B perform the following processing.

The on-screen processor 113A sets a display form of the to-be-displayed device information 171 where the cursor 172 is positioned in a manner to be different from that of other to-be-displayed device information 171. For instance, as shown in FIG. 12, the on-screen processor 113A sets a color of the to-be-displayed device information 171 of “HDMI1” (shown as a shaded area) in a manner different from that of other to-be-displayed device information 171.

When a display name of the screen display name information 165 is changed by the user, the on-screen processor 113A displays the connection information 170 shown in FIG. 13.

The display input extension processing controller 113B recognizes that a device represented by the to-be-displayed device information 171 indicated by the cursor 172 is determined as a device for outputting the content. The display input extension processing controller 113B transmits a determination signal to the effect to such a selected device and a device interposed between the selected device and the display device 100. After receiving the determination signal, each of the devices is actuated and notifies the reception.

For instance, as shown in FIG. 12, when the determination button 10C is pressed while the cursor 172 is positioned at “HDMI1” in the to-be-displayed device information 171, the display input extension configuration memory processing controller 113B recognizes the device of “HDMI1” as the first video sound output device 401 based on the optimized connection configuration list 160 and transmits a determination signal to the first video sound output device 401. After receiving the determination signal, the first video sound output device 401 is actuated by the power supplied from the power supply controlling unit and notifies the actuation by a notifier.

When the seventh video output device 407 corresponding to “HDMI7-2” is selected, the seventh video sound output device 407, the HDDVD recorder 300 and the AV receiver 200 are actuated by the power supplied from the power supply controlling units 407E, 309 and 214 to the video processor 407D and 306 and the video transfer processor 211, and notify the actuation by a notifier. However, the HDDVD recorder 300 and the AV receiver 200 may be arranged not to notify the actuation.

Further, the display input extension processing controller 113B receives information about an image adjustment state based on the image-quality adjustment setting information 166 of the optimized connection configuration list 160 and outputs the received information to the video switch processor 114. After receiving the information about the adjustment state, the video switch processor 114 receives a content signal from a device designated by the determination button 10C and adjusts an image quality and a screen size of a content of the content signal as needed to instruct the display section 111 to display the adjusted image quality and the screen size.

For instance, when the first video sound output device 401 is determined as a device for outputting the content, the video switch processor 114 adjusts the content based on the content signal from the first video sound output device 401 under the conditions stored in the setting-memory area 1 and instructs the display section 111 to display the adjusted content.

### Advantages of AV System

As described above, the following advantages can be obtained in the above exemplary embodiment.

(1) When the first to seventh video sound output devices 401 to 407 are connected to the first to fourth input terminals 101 to 104 via the AV receiver 200 or the HDDVD recorder 300, the display device 100 of the AV system 1 recognizes such a connection by the display input extension processing controller 113B of the connection state display controller 113. The display input extension processing controller 113B includes the optimized connection configuration information 161 about the first to seventh video sound output devices 401 to 407 and the HDDVD recorder 300 which have the stored content transmitting function, and creates the optimized connection configuration list 160 without the optimized connection configuration information 161 about the AV receiver 200 which has no stored content transmitting function. Subsequently, the on-screen processor 113A of the connection state display controller 113 instructs the display section 111 to display the connection information 170 based on the optimized connection configuration list 160, the connection information 170 having the to-be-displayed device information 171 for the devices including the stored content transmitting function and not having the to-be-displayed device information 171 for the devices including no stored content transmitting function.

Accordingly, even when a number of devices only having a repeater function are connected between the display device 100 and the device having the stored content transmitting function, the to-be-displayed device information 171 only for a device having a stored content transmitting function can be displayed so that the user can easily specify the device having the stored content transmitting function.

(2) The display input extension processing controller 113B changes the contents of the screen display name information 165 according to the user's operation of the remote controller 10. The on-screen processor 113A displays the to-be-displayed device information 171 based on the changed screen display name information 165.

Accordingly, the to-be-displayed device information 171 can be changed according to user's demands and the user can easily specify the device having the stored content transmitting function.

(3) When the predetermined device in the to-be-displayed device information 171 is determined as a device for outputting the content, the on-screen processor 113A sets a color of the to-be-displayed device information 171 in a manner to be different from that of other to-be-displayed device information 171.

Accordingly, the user can easily specify the device for outputting the content which is displayed on the display device 100.

(4) The video switch processor 114 displays a content based on the image adjustment conditions based on the image-quality adjustment setting information 166 of the optimized connection configuration list 160.

Accordingly, a content of which image quality and the like are adjusted under conditions according to the user's demands can be displayed at every input terminals 101 to 104. Particularly, since the image-quality adjustment setting information 166 is given at every input terminals 101 to 104, even when the device connected to each of the input terminals 101 to 104 is changed, a content adjusted under the same conditions can be displayed.

(5) On receiving the determination signal, the first to seventh video sound output devices 401 to 407, the AV receiver 200 and the HDDVD recorder 300 which are connected to the display device 100 are actuated by the power supplied from the power supply controlling unit 214, 309 and 407E.

Accordingly, without performing an operation for actuating outputting devices such as the first to seventh video sound output devices 401 to 407 and the HDDVD recorder 300 and a transfer device such as the AV receiver 200, the outputting devices and the transfer device can be actuated and the user can easily perform the operation of the AV system 1.

(6) On receiving the determination signal, the first to seventh video sound output devices 401 to 407, the AV receiver 200 and the HDDVD recorder 300 which are connected to the display device 100 notify such a determination by the notifiers 215, 310 and 407F.

Accordingly, the user can easily specify the device for outputting the content and the transfer device.

(7) The HDDVD recorder 300 having a repeater function and a stored content transmitting function is applied as the first transmitter of the invention.

Accordingly, in addition to the contents from the first to seventh video sound output devices 401 to 407 located at ends of the tree-structured connection, a content from the HDDVD recorder 300 interposed between the devices at the ends and the display device 100 can also be displayed as the display device 100. Consequently, the AV system 1 that can output contents from a larger number of devices can be provided.

(8) Screen display name information 165 of a device having a repeater content transmission function and a device connected to the display device 100 via the device having a repeater content transmission function, is named by characters according to a rule different from screen display name information 165 of a device directly connected to the display device 100 and a device connected thereto via a device only having a repeater function. The display device 100 displays to-be-displayed device information 171 based on the screen display name information 165.

Accordingly, by only visually recognizing the to-be-displayed device information 171, the user can recognize a function and a connection state of a device corresponding to the to-be-displayed device information 171.

(9) The devices of the AV system 1 are connected to each other via an HDMI cable having lines for transmitting a video signal, image signal and control signal.

Accordingly, wiring operation can be facilitated as compared with an arrangement of connection via cables each having a line for transmitting each one of the video signal, image signal and control signal.

### Modifications of Embodiment(s)

The scope of the invention is not limited to the above-described embodiment, but includes the following modifications as long as an object of the invention can be achieved.

Specifically, the to-be-displayed device information 171 for the device capable of transmitting the content signal and the to-be-displayed device information 171 for the device incapable of transmitting the content signal may be displayed in different display forms. Herein, examples of the arrangement for displaying the to-be-displayed device information 171 in different display forms include a first arrangement for displaying only the to-be-displayed device information 171 for the device capable of transmitting the content, a second arrangement for changing brightness, color and size of the both to-be-displayed device information 171 and a third arrangement for displaying information about whether a device is capable of transmitting or not. Details of the third arrangement will be described below.

Firstly, for instance, each of the devices is in a setting state as follows.

Setting States

the first video sound output device 401: incapable of transmitting the content signal (a DVD is not inserted),
the second video sound output device 402: capable of transmitting the content signal (tuned and under recording, but capable of transmitting the video under recording),
the third video sound output device 403: incapable of transmitting the content signal (a DVD is not inserted),
the fourth video sound output device 404: capable of transmitting the content signal (a DVD is inserted),
the fifth video sound output device 405: capable of transmitting the content signal (not under recording, already tuned and having a recorded content in HDD),
the sixth video sound output device 406: capable of transmitting the content signal (not under recording, already tuned and no HDD mounted),
the seventh video sound output device 407: capable of transmitting the content signal (currently outputting the content signal recorded in the memory to the HDDVD recorder 300), and
HDDVD recorder 300: capable of transmitting the content signal (under recording the content signal from the seventh video sound output device 407 to the HDD and already tuned)

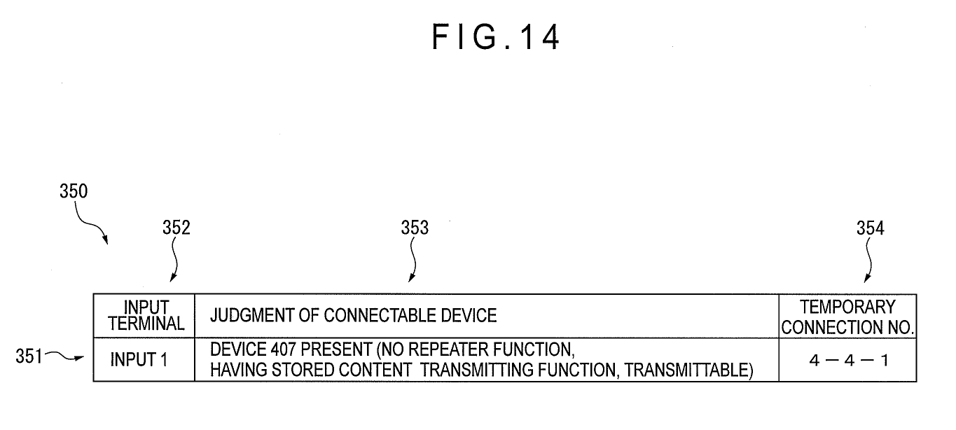

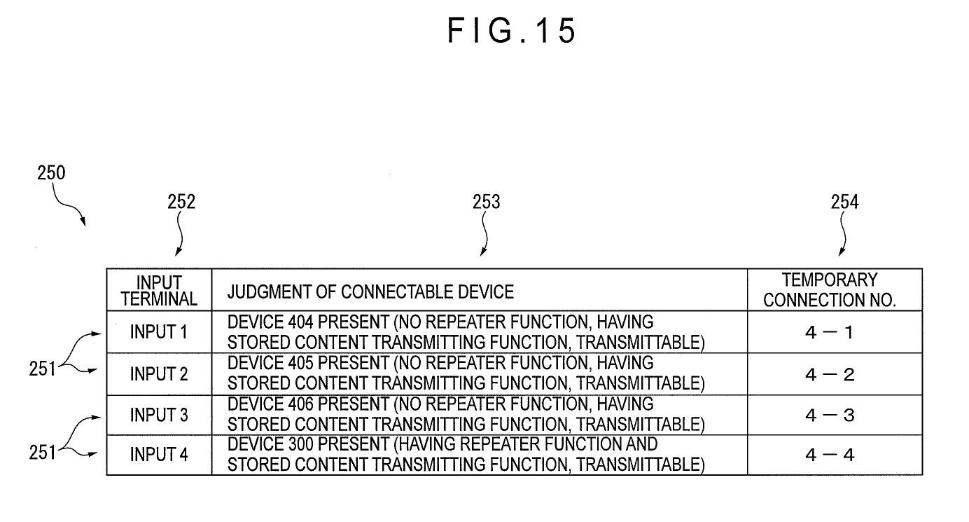

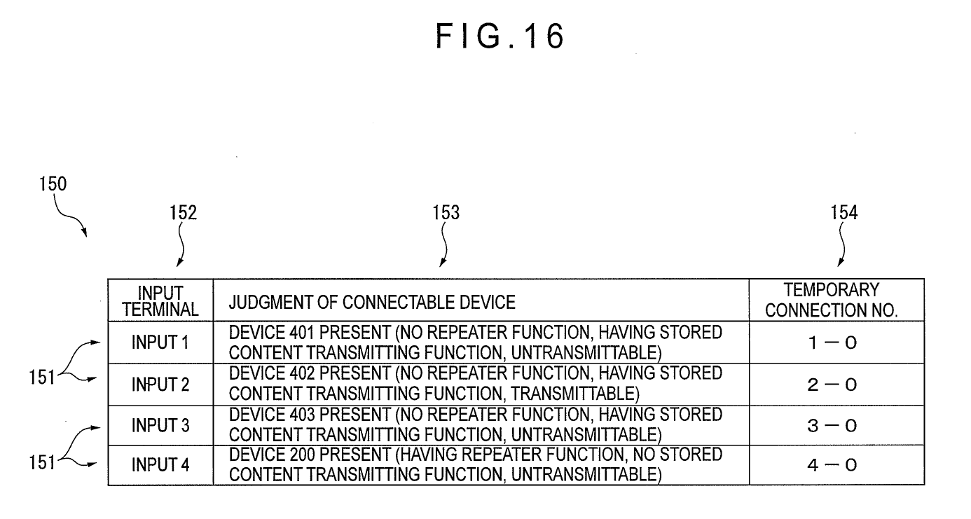

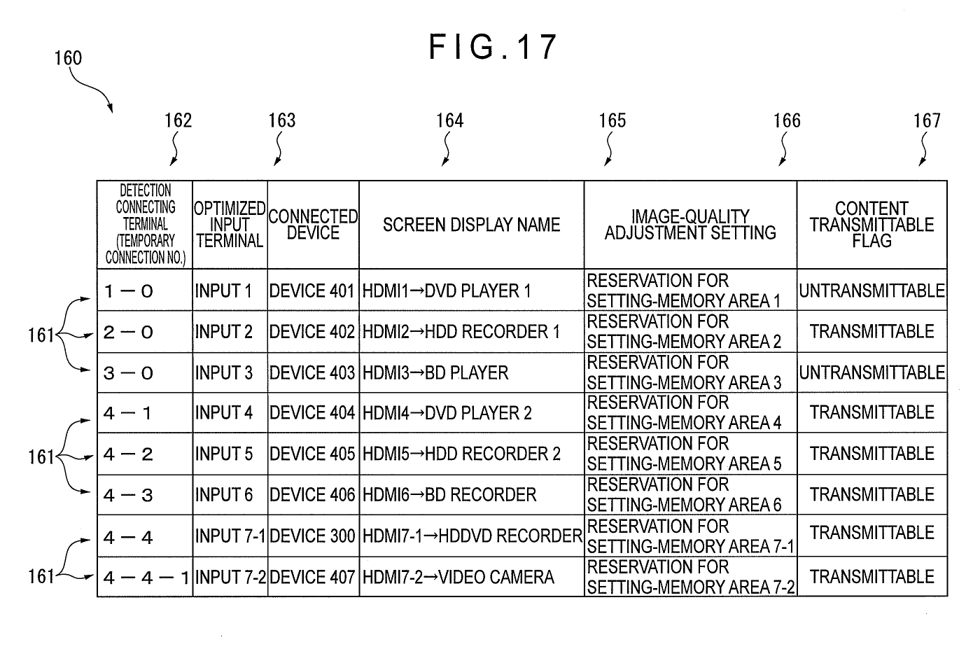

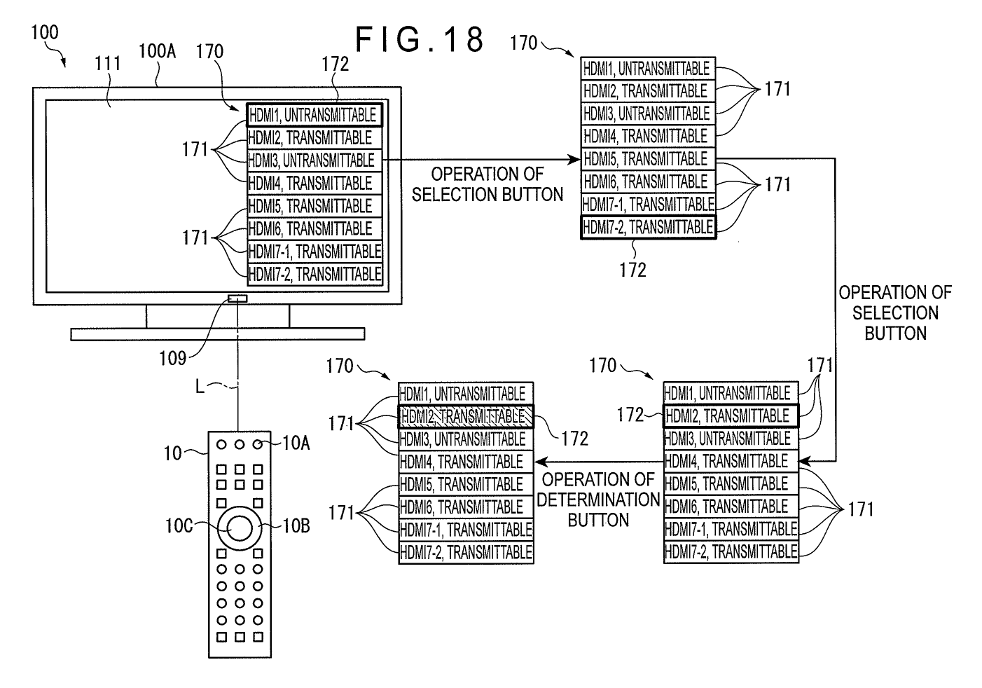

For instance, as shown in FIGS. 14 to 16, when checking the connection states of the devices, the display device 100 recognizes whether each of the devices is capable of transmitting the content signal and adds flag information to respective connected device judgment information 353, 253 and 153 of the input terminal lists 350, 250 and 150, the flag information including “capable of transmission” indicating the each of the devices is capable of transmitting the content signal and “incapable of transmission” indicating the each of the devices is incapable of transmitting the content signal. Subsequently, as shown in FIG. 17, the display device 100 creates the optimized connection configuration list 160 in which the information indicating “capable of transmission” or “incapable of transmission” is recorded in contents-transmittable flag information 167 based on the each of the input terminal lists 350, 250 and 150. As shown in FIG. 18, the display device 100 creates the to-be-displayed device information 171 for displaying characters of “capable of transmission” or “incapable of transmission” in addition to the display names of the terminals.

With this arrangement, the user can easily specify the device capable of transmitting the content signal, in other words, a device capable of reproducing the content.

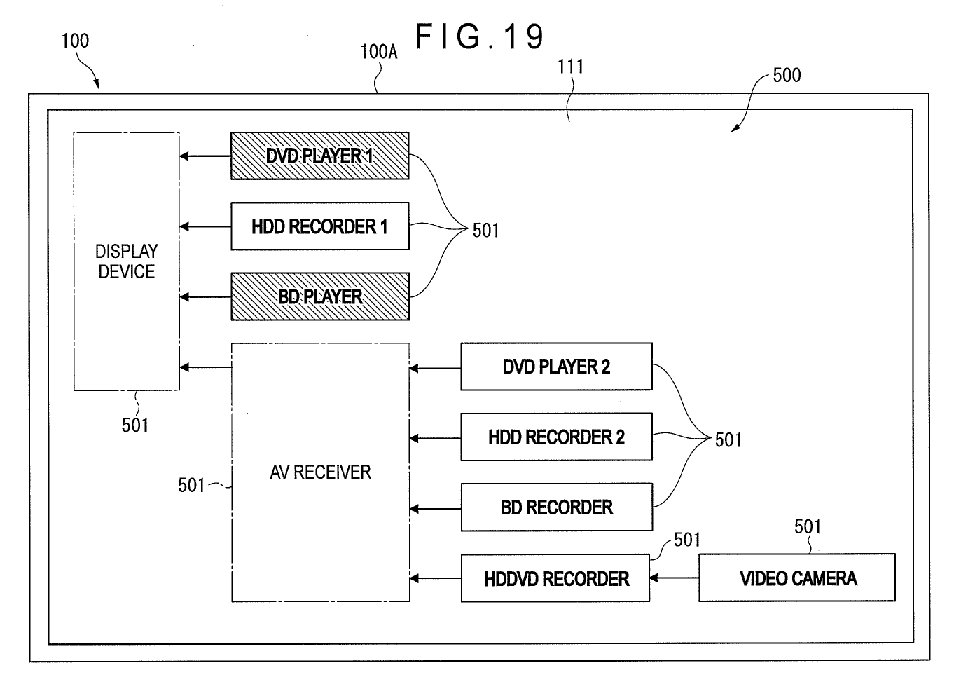

As shown in FIG. 19, connection information 500 may be displayed in a display form different in which the to-be-displayed device information 501 for a device having a stored content transmitting function and the to-be-displayed device information 501 for a device only having a repeater function are displayed in different formats. Specifically, the brightness of the to-be-displayed device information 501 for the display device 100 and the AV receiver 501 only having the repeater function may be decreased (in FIG. 19, represented by surrounding the to-be-displayed device information 501 by a dashed line), whereas the brightness of the to-be-displayed device information 501 for the first to seventh video sound output devices 401 to 407 (a first DVD player, first HDD recorder, BD player, second DVD player, second HDD recorder, BD recorder and video camera) and HDDVD 300 having a stored content transmitting function may be increased (In FIG. 19, represented by surrounding the to-be-displayed device information 501 by a single line).

Even with this arrangement, the user can easily specify a device having a stored content transmitting function depending on brightness.

In the arrangement shown in FIG. 19, for instance, when the first DVD player and the BD player are incapable of transmitting the content signal and other devices are capable of transmitting the content signal, a color (shown in shaded area) of the to-be-displayed device information 501 representing the first DVD player and the BD player may be different from that of the to-be-displayed device information 501 for the other devices.

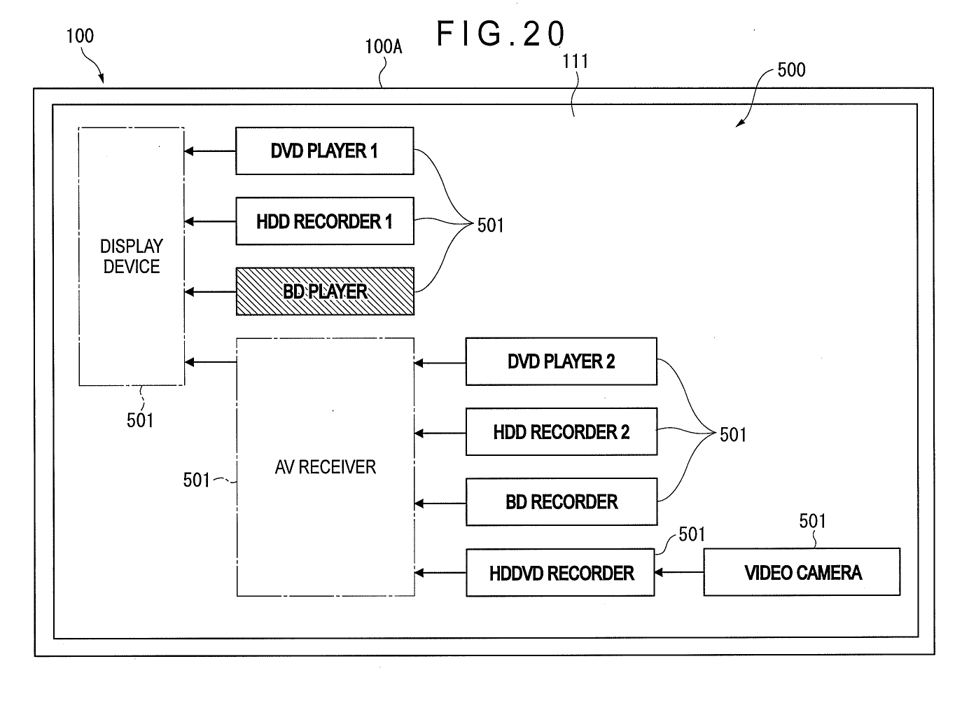

Further, in the arrangement shown in FIG. 19, for instance, when it is recognized that a DVD is inserted in the first DVD player and the state of the first DVD player has changed from the state incapable of transmission to the state capable of transmission, as shown in FIG. 20, a color of the first DVD player as the to-be-displayed device information 501 may be changed to a color representing transmittable state thereof. With this arrangement, the user can easily specify a device in which a DVD to be highly possibly reproduced is inserted. When the DVD is taken out from the first DVD player, the color of the to-be-displayed device information 501 may be returned to the color representing untransmittable state.

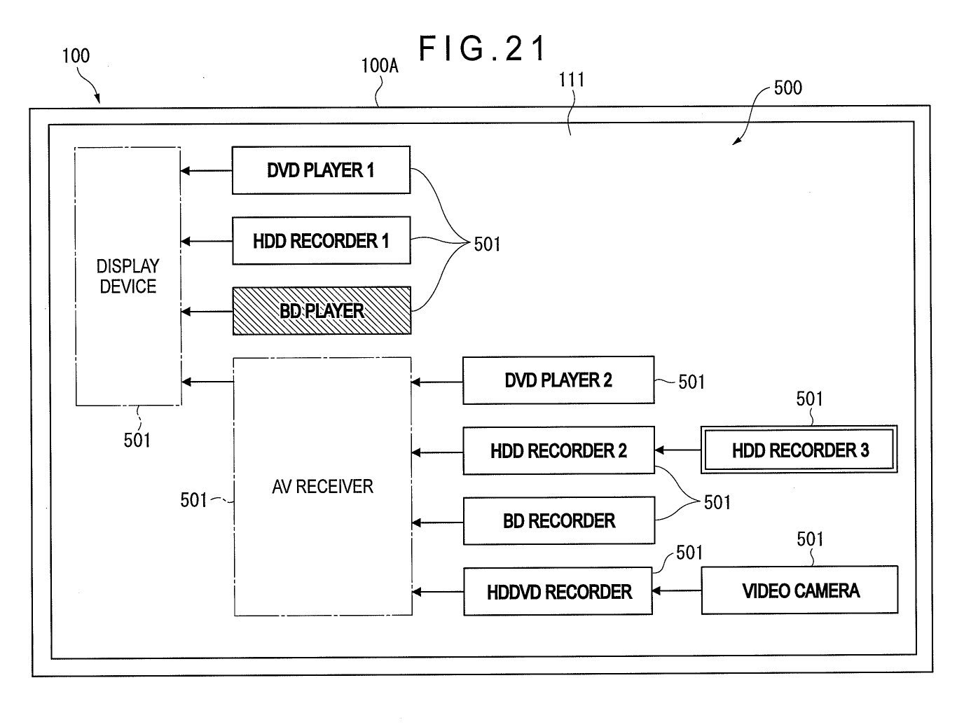

Moreover, in the arrangement shown in FIG. 20, connection of the third HDD recorder capable of transmitting the content signal to the second HDD recorder may be recognized and, as shown in FIG. 21, the to-be-displayed device information 501 for the newly connected third HDD recorder may be flashed (in FIG. 21, represented by surrounding the to-be-displayed device information 501 by a double line). A display form of the third HDD recorder may be changed in the same manner as the device entering the untransmittable state to the transmittable state. With this arrangement, the user can easily specify a device newly connected to the AV system 1.

The display input extension processing controller 113B may not be provided with a function for changing the screen display name information 165.

Further, when the predetermined device indicated by the to-be-displayed device information 171 is designated as the device for outputting the content, the on-screen processor 113A may not be designed to change the color of the to-be-displayed device information 171. Alternatively, without changing the color of the to-be-displayed device information 171, to-be-displayed device information 171 may be flashed.

Without providing the image-quality adjustment setting information 166 to the optimized connection configuration list 160, the image may be adjusted according to the operation of the remote controller 10 at the video switch processor 114.

Even when a device for outputting the content is determined by the operation of the determination button 10C, the device for outputting the content may not be actuated or the determination may not be notified by the outputting device.

Moreover, screen display name information 165 of a device having a repeater content transmission function and a device connected to the display device 100 via the device having a repeater content transmission function may be named by characters determined according to the same rule as screen display name information 165 of a device directly connected to the display device 100 and a device connected thereto via a device only having a repeater function. In other words, the characters of “HDMI7-1” and “HDMI7-2” shown in the screen display name information 165 of FIG. 8 may be represented by “HDMI7” and “HDMI8.”

The screen display name information 165 of the device having a repeater content transmission function may be named by characters determined according to a rule different from the device connected to the display device 100 via the device having a repeater content transmission function. In other words, the characters of “HDMI7-2” shown in the screen display name information 165 of FIG. 8 may be represented by “HDMI7-1-1.”

The invention may be applied for the arrangement of connection via cables each having a line only for transmitting each one of the video signal, image signal and control signal.

While the content signal output from the seventh video sound output device 407 is stored in the storage 305 of the HDDVD recorder 300, the content based on the content signal may be displayed on the display device 100. Further, while the content signal output from the seventh video sound output device 407 is stored in the storage 305 of the HDDVD recorder 300, a content based on the other content signals stored in the storage 305 may be displayed on the display device 100.

As the transmitter having the content generating function of the invention, a device provided with a tuner as a distributed content transmitter that receives a content signal distributed from a server and a broadcast station as a distributing device and transmits the content signal may be applied.

In addition, although the functions are constructed in the form of programs in the above description, the functions may be arranged in a hardware such as a circuit board, in an element such as an IC (integrated circuit), or in any other suitable manner. When an arrangement in which a program or suitable recording media is read out is employed, handling can be facilitated in the above arrangements, thereby achieving a wide utilization of the technique.

Specific structures and processes in performing the invention may alternatively be arranged as long as they are compatible with an object of the invention.

### Advantages of Embodiments

As described above, in the above exemplary embodiment, when the display device 100 of the AV system 1 is connected with the first to seventh video sound output devices 401 to 407 via the AV receiver 200 and the HDDVD recorder 300 at the first to fourth input terminals 101 to 104, the display device 100 instructs the display section 111 to display the connection information 170 including the to-be-displayed device information 171 about the first to seventh video sound output devices 401 to 407 and the HDDVD recorder 300 having a stored content transmitting function, and the HDDVD recorder 300 and not including the to-be-displayed device information 171 about the AV receiver 200 having no stored content transmitting function.

Accordingly, even when a number of devices only having a repeater function are connected between the display device 100 and the device having the stored content transmitting function, to-be-displayed device information 171 only for a device having a stored content transmitting function can be displayed and the user can easily specify the device having the stored content transmitting function.

### INDUSTRIAL APPLICABILITY

The invention is applicable as a connection state display controller to instruct a display section to display a connection state when a transmitter is connected to an input terminal of a content processor via a transfer unit, a content processor, a content processing system, a connection state display control method, a program thereof and a recording medium that records the program.

1. A connection state display controller provided in a content processor comprising a display section capable of displaying various information, an input terminal capable of inputting a content signal having at least one of a sound signal and an image signal and a content processing section that processes the content signal to be input via the input terminal,
wherein, when a signal processor having a content generating function for generating the content signal is provided as a transmitter, and a signal processor not having the content generating function but having a content transfer function for transferring the content signal is provided as a transfer device, the transmitter for transmitting the content signal is connected to the input terminal via the transfer device, the connection state display controller instructs the display section to display a connection state between the transmitter and the transfer device, the connection state display controller comprising:
a connection information generating unit that recognizes the connection state to generate connection information including to-be-displayed device information for specifying the transmitter and the transfer device respectively; and
a connection information display controlling unit that instructs the display section to display only the to-be-displayed device information for the transmitter, or instructs the display section to display the to-be-displayed device information for the transmitter and the to-be-displayed device information for the transfer device in different display forms.

2. The connection state display controller according to claim 1, wherein
the connection information generating unit generates the connection information having the to-be-displayed device information including information for specifying whether the transmitter is capable of performing a content generating function, and
when the transmitter is incapable of performing the content generating function, the connection information display controlling unit instructs the display section to display the to-be-displayed device information for the transmitter capable of performing the content generating function and the to-be-displayed device information for the transmitter incapable of performing the content generating function in different display forms, or instructs the display section not to display the to-be-displayed device information for the transmitter incapable of performing the content generating function.

3. The connection state display controller according to claim 2, wherein
the connection information generating unit recognizes change in an executable function in the transmitter and regenerates the connection information, and
when the transmitter is changed from a state where the transmitter is incapable of performing the content generating function to a state where the transmitter is capable of performing the content generating function, the connection information display controlling unit instructs the display section to display the to-be-displayed device information for the transmitter of which state is changed in a display format different from the display form of the to-be-displayed device information for the transmitter capable of performing the content generating function before the change.

4. The connection state display controller according to claim 1, wherein
the connection information generating unit recognizes a change in the connection state and regenerates the connection information, and
when a transmitter is newly connected, the connection information display controlling unit instructs the display section to display to-be-displayed device information for the newly connected transmitter and to-be-displayed device information for the transmitter already connected in different display forms.

5. The connection state display controller according to claim 1, wherein
the connection information generating unit changes a content of the to-be-displayed device information according to an input operation.

6. The connection state display controller according to claim 1, wherein
the content processor comprises a plurality of input terminals, and
when the connection information display controlling unit recognizes a determination that the content signal of any one of the transmitter specified by the connection information is processed by the content processing unit, the connection information display controlling unit instructs the display section to display the to-be-displayed device information of the any one of the transmitters and to-be-displayed device information of other transmitters in different display forms.

7. The connection state display controller according to claim 1, wherein
the transmitter comprises a first transmitter and a second transmitter,
the second transmitter being connected to the input terminal via the first transmitter,
the first transmitter comprises: a transmitted content transfer section that transfers a content signal transmitted from the second transmitter; a storage that stores the content signal; and a stored content transmission section that generates the content signal by receiving and transmitting the stored content signal in the storage, and
the connection information generating unit generates the connection information having the to-be-displayed device information for specifying the first and second transmitters.

8. The connection state display controller according to claim 1, wherein
the transmitter comprises a first transmitter and a second transmitter,
the second transmitter being connected to the input terminal via the first transmitter,
the first transmitter comprises: a transmitted content transfer section that transfers a content signal transmitted from the second transmitter; and a distributed content transfer section that generates the content signal by receiving and transmitting the content signal distributed from a distributing device, and
the connection information generating unit generates the connection information having the to-be-displayed device information for specifying the first and second transmitters.

9. The connection state display controller according to claim 7, wherein
the to-be-displayed device information includes:
first to-be-displayed device information for the first transmitter;
second to-be-displayed device information for the second transmitter; and
third to-be-displayed device information for a third transmitter connected to the input terminal without interposing the first transmitter therebetween, and
among the to-be-displayed device information, the connection information generating unit sets a content of the third to-be-displayed device information according to a rule different from a rule for setting the first to-be-displayed device information and the second to-be-displayed device information.

10. A content processor, comprising:
a display section capable of displaying various information;
an input terminal capable of inputting a content signal having at least one of a sound signal and an image signal;
a content processing section that processes the content signal to be input via the input terminal; and
the connection state display controller according to claim 1.

11. The content processor according to claim 10, further comprising:
a plurality of the input terminals; and
an input terminal processing information storage that stores input terminal information for specifying the input terminals and input terminal processing information having processing type information for a processing type of the content signal to be input via the input terminals, wherein
the content processing section recognizes the input terminals into which the content signal to be processed is input and processes the content signal according to a processing type based on the processing type information of the input terminal processing information corresponding to the recognized input terminals.

12. A content processing system, comprising:
the content processor according to claim 10;
the transmitter; and
the transfer device.

13. The content processing system according to claim 12, wherein
the content processor comprises a determination signal transmitting unit that transmits a determination signal to one of the transmitters specified by the connection information, the determination signal being sent when the content processor recognizes a determination that the content signal of the one of the transmitters is processed by the content processing unit; and
the transmitter comprises an power supply controlling unit that actuates supplying power to the content transmitter when receiving the determination signal.

14. The content processing system according to claim 12, wherein
the content processor comprises a determination signal transmitting unit that transmits a determination signal to one of the transmitters specified by the connection information, the determination signal being sent when the content processor recognizes a determination that the content signal of the one of the transmitters is processed by the content processing unit; and
the transmitter comprises a notifier for notifying a reception of the determination signal.

15. A connection state display control method serving as a computer provided in a content processor comprising a display section capable of displaying various information, an input terminal capable of inputting a content signal having at least one of a sound signal and an image signal and a content processing section that processes the content signal to be input via the input terminal,
wherein, when a signal processor having a content generating function for generating the content signal is provided as a transmitter, and a signal processor not having the content generating function but having a content transfer function for transferring the content signal is provided as a transfer device, the transmitter for transmitting the content signal is connected to the input terminal via the transfer device, the connection state display controller instructs the display section to display a connection state between the transmitter and the transfer device,
the computer recognizing the connection state to generate connection information including to-be-displayed device information for specifying the transmitter and the transfer device respectively, and
instructing the display section to display only the to-be-displayed device information for the transmitter, or instructs the display section to display the to-be-displayed device information for the transmitter and the to-be-displayed device information for the transfer device in different display forms.

16-18. (canceled)

19. The connection state display controller according to claim 8, wherein the to-be-displayed device information includes:
first to-be-displayed device information for the first transmitter;
second to-be-displayed device information for the second transmitter; and
third to-be-displayed device information for a third transmitter connected to the input terminal without interposing the first transmitter therebetween, and
among the to-be-displayed device information, the connection information generating unit sets a content of the third to-be-displayed device information according to a rule different from a rule for setting the first to-be-displayed device information and the second to-be-displayed device information.

20. A recording medium that records a connection state display controlling program to instruct a computer to execute the connection state display controlling method according to claim 15, in a manner readable by a computer.

21. A recording medium that records a connection state display controlling program to instruct a computer to serve as the connection state display controlling method according to claim 1, in a manner readable by a computer.
